(19) United States
(12) Patent Application Publication
(10) Pub. No.: US 2006/0192885 A1
(43) Pub. Date: Aug. 31, 2006

(54) Miniature camera bias spring

(75) Inventors: Robert J. Calvet, Pasadena, CA (US); Roman C. Gutierrez, Arcadia, CA (US); Darrell Harrington, Pasadena, CA (US)

Correspondence Address: MACPHERSON KWOK CHEN & HEID LLP, 1762 TECHNOLOGY DRIVE, SUITE 226, SAN JOSE, CA, 95110, US

(73) Assignee: Siimpel

(21) Appl. No.: 11/219,259

(22) Filed: Sep. 2, 2005

Related U.S. Application Data
(60) Provisional application No. 60/657,261, filed on Feb. 28, 2005.

(51) Int. Cl. G03B 13/00

(52) U.S. Cl. 348/345

(57) ABSTRACT

A method and system for biasing focusing optics of a miniature camera in a predetermined position are disclosed. A spring can be used to bias the optics in a position for focus at infinity. Such biasing mitigates power consumption, provides a failsafe feature, and mitigates the detrimental effects associated with the use of autofocus upon a subject having fuzzy features.

### PRIORITY CLAIM

This patent application claims the benefit of the priority date of U.S. provisional patent application serial No. 60/657,261, filed on Feb. 28, 2005 and entitled AUTOFOCUS CAMERA (docket no. M-15826-V1 US) pursuant to 35 USC 119. The entire contents of this provisional patent application are hereby expressly incorporated by reference.

### TECHNICAL FIELD

The present invention relates generally to miniature cameras such as those used in cellular telephones. The present invention relates more particularly to the use of a spring for biasing optics of a miniature camera to a predetermine position thereof.

### BACKGROUND

Miniature cameras are well known. Miniature cameras are widely used in contemporary cellular telephones. They are also used in other devices, such as laptop computers and personal digital assistants (PDAs). Miniature cameras can even be used as stand alone devices for such applications as security and surveillance.

Contemporary miniature cameras, such as those used in cellular telephones, are fixed focus cameras. That is, the focus of the cameras is preset. The camera has a small enough aperture so as to provide sufficient depth of field such that focus is generally acceptable over a wide range of distances. However, such stopping down of the camera severely limits it's use in low light conditions.

Variable focus necessitates the use of movable optics. However, movable optics suffer from inherent disadvantages, such as increased power consumption and the potential for failure. Further, it is sometimes difficult to determine where such movable optics should be positioned when a subject has fuzzy features (which inhibit the accurate use of autofocus).

It is desirable to provide movable optics for a miniature camera, such as for variable focus, wherein power consumption is mitigated, failsafe operation is facilitated, and the detrimental effects of a subject's fuzzy features upon autofocus are mitigated.

### BRIEF SUMMARY

A method and system for biasing optics of a camera in a predetermined position are disclosed. For example, a spring can be used to bias the focusing optics of a miniature camera in a default or starting position that enhances the utility of the miniature camera.

According to one embodiment of the present invention, a bias spring urges an optics assembly of the camera to one extreme limit of its motion, i.e., the infinity focus position. More specifically, in accordance with one embodiment of the present invention the focusing optics of a miniature camera are formed upon a stage and the bias spring urges an actuator of the stage into a predetermined position such that the optics are at the infinity focus position.

According to one aspect of the present invention, the spring can be a coiled compression spring formed of a non-magnetic material. One end of the spring contacts the armature of the actuator and the other end of the spring contacts a fixed portion of the miniature camera, such as a structure of the housing thereof. Thus, the bias spring urges the armature, and consequently the optics assembly which is attached to the armature via the stage, into the desired position.

In one embodiment, the miniature camera is part of a cellular telephone. In other embodiments, the miniature camera can be a stand-alone device or can be part of another device, such as a portable electronic device.

Such biasing of the focusing optics mitigates power consumption, provides a failsafe feature, and mitigates the detrimental effects associated with the use of autofocus upon a subject having fuzzy features.

This invention will be more fully understood in conjunction with the following detailed description taken together with the following drawings.

### BRIEF DESCRIPTION OF THE DRAWINGS

FIG. 1 is a semi-schematic perspective view of a miniature camera having a bias spring for moving autofocus optics to a position for focus at infinity, according to an exemplary embodiment of the present invention;

FIG. 2 is a semi-schematic exploded perspective view of the miniature camera of FIG. 1;

FIG. 3 is a semi-schematic enlarged perspective view of the coils (the stator) of the actuator of FIG. 2;

FIG. 4 is a semi-schematic enlarged perspective view of the magnet assembly, (the armature) and the stage assembly of FIG. 2, with the coils disposed intermediate the magnets of the magnet assembly;

FIG. 5 is a semi-schematic enlarged perspective view of the magnet assembly and stage assembly of FIG. 4, with the coils removed therefrom;

FIG. 6 is a semi-schematic enlarged perspective view of the armature of FIG. 2, with the coils disposed intermediate the magnets thereof and with the stage assembly removed;

FIG. 7 is a semi-schematic perspective view of the frame of FIG. 6; and

FIG. 8 is a semi-schematic perspective view of a cellular telephone having a miniature camera, according to one embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION OF THE INVENTION

A method and system for biasing optics of a camera are disclosed. For example, the focusing optics of a camera can be biased at an infinity focus position so as to provide a default or initial position thereof that reduces power consumption of the camera, provides a failsafe mode of operation in the event that optics movement is inhibited, and mitigates the detrimental effects associated with attempting to used autofocus on a subject that has fuzzy features.

Power consumption can be reduced by biasing the focusing optics at infinity focus. When the focusing optics are biased at infinity focus, this becomes the default or power off position of the focusing optics, such that it is the starting position of the focusing lens when focusing is performed to capture an image with the camera. More scenes tend to be imaged with the focus at or close to infinity focus than at near focus. By biasing the focusing optics at infinity focus, less travel of the focusing optics is likely to be necessary, on average. Thus, less power is likely to be consumed moving the focusing optics, on average. This reduction in power consumption can be particularly advantageous when the camera is a portable device or part of a portable device that uses batteries, since battery life is extended proportionally.

The optics movement mechanisms, such as the motor or actuator and the mechanical structures associated with restraining and/or guiding movement of the optics, are all subject to failure. By biasing the focusing optics at infinity, the likelihood of any failure resulting in permanent focusing at infinity is enhanced. That is, failure is more likely to result in infinity focus than any other focus.

As those skilled in the art will appreciate. Focus at infinity tends to provide the most useful of all possible focuses, on average. That is, the majority of photographs taken tend to be done with focus at or near infinity. Thus, biasing the focusing optics at infinity focus provides some degree of failsafe operation. The camera tends to maintain a greater degree of utility when focus is limited to infinity than it does when focus is limited to some other position.

Focusing optics can be moved so as to facilitate autofocusing of a camera. Although autofocus generally provides satisfactory results, it can provide less desirable results when a subject has fuzzy features. Autofocus generally functions by attempting to determine a focus that provides the most distinct or crisp (non-fuzzy) image. When a subject has fuzzy features, the difficulty or inability of the autofocus mechanism to provide a crisp image can inhibit the use of autofocus. When this occurs, providing a default focus at infinity can be a desirable alternative. That is, when the autofocus mechanism is ineffective, the camera can be caused to use infinity focus. As discussed above, infinity focus provides adequate results for many photographs.

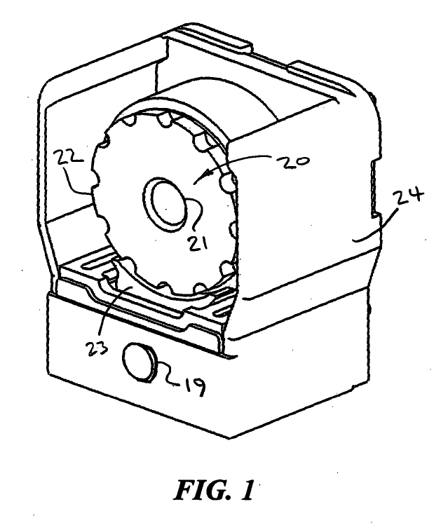

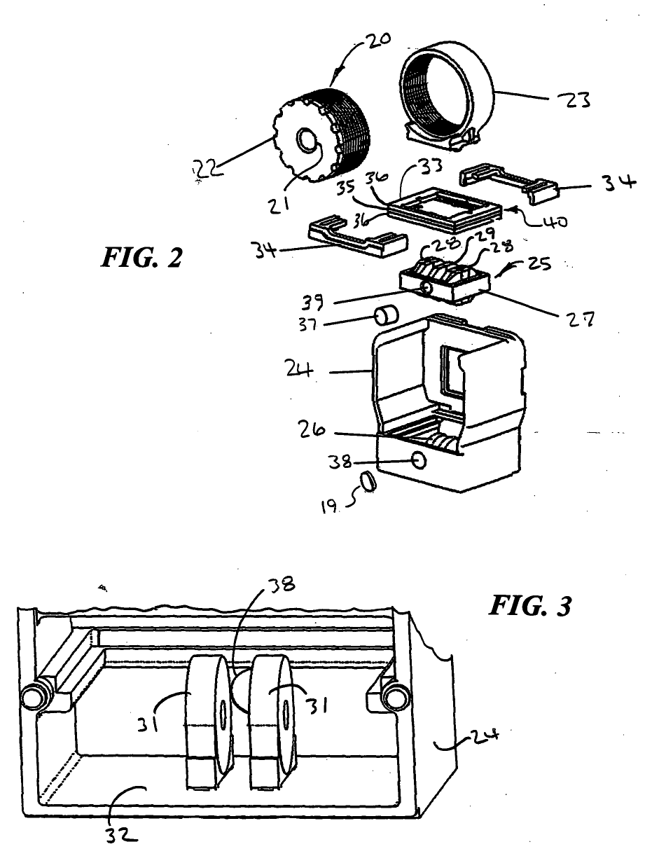

Referring now to FIGS. 1 and 2, an actuator can be used to move elements of a miniature camera optics assembly 20. The actuator is biased so as to provide infinity focus according to one embodiment of the present invention. Such biasing of the actuator causes an optics assembly 20 to move to an infinity focus position when the actuator is not causing optics assembly 20 to be at some other position (for focus at other than infinity). The actuator can move optics assembly 20 so as to provide focus at a variety of different distances, e.g., from a few feet away to infinity.

Optics assembly 20 can comprise, for example, a focusing lens 21 that is held by a lens holder 22. Lens holder 22 is attached, such as via threads, to a lens ring 23. Lens ring 23 can be caused to move linearly by the actuator. A housing 24 generally surrounds the components of optical assembly 20. Focusing lens 21 focuses an image upon an imaging sensor (not shown).

With particular reference to FIG. 2, the actuator comprises a magnet assembly 25 and a coil assembly 26. Magnet assembly 25 defines an armature of the actuator and coil assembly 26 defines a stator thereof. Magnet assembly 25 comprises a frame 27 that holds outboard magnets 28 and inboard magnet 29 in place with respect to one another. Coil assembly 26 comprises two coils 31 (best shown in FIG. 3).

Magnet assembly 25 is attached to a stage 35 of stage assembly 40. Stage 35 is attached to lens ring 23. Thus, movement of the armature or magnet assembly 25 causes lens 21 to move and thereby effect focusing of a miniature camera. Axial snubbers 34 limit axial movement of stage 35 to a maximum (infinity) and a minimum (typically a few inches or a few feet) focus distance. Snubber assemblies 36 of stage assembly 40 control movement of stage 35 in six degrees of freedom, so as to allow translation in one degree of freedom while substantially inhibiting movement in all other degrees of freedom.

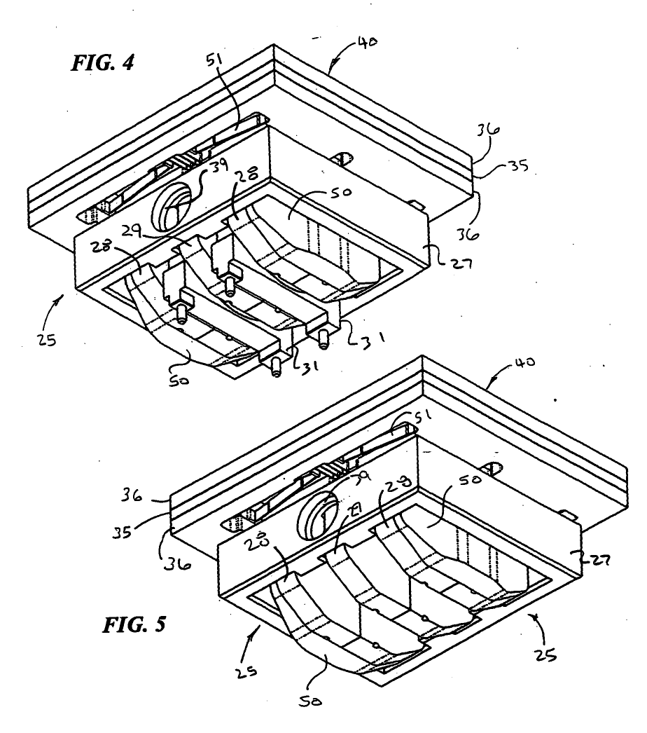

Biasing spring 37 can be inserted through spring aperture 38 of housing 24 and placed into contact with spring seat 39 (better shown in FIGS. 4, 5, and 7) so as to bias armature or magnet assembly 25 (and consequently optics assembly 20 and lens 21) toward one end of housing 24 (so as to provide infinity focus). Biasing lens 21 toward one end of housing 24 such that it moves to a known position when current is not flowing through coils 31 can be used to provide a known location of lens 21 on power up and also to provide a comparatively stable position of stage 35 that enhances resistance to mechanical shock.

Biasing spring 37 can comprise a coiled compression spring formed of a non-magnetic material. The use of a non-magnetic material such as beryllium copper can be done so as to inhibit undesirable interference with the operation of the actuator or other electric/magnetic parts. Other types of springs may also be utilized. Indeed, the spring can be formed of stainless steel, particularly when interference with electrical/magnetic parts is not a concern. More than one spring may be used, if desired.

According to one aspect of the present invention, biasing spring 27 is compressed intermediate housing 24 and the armature or magnet assembly 25. A cap 19 holds bias spring 37 in place after it is inserted through opening 38 in housing 24. The cap can be adhesively bonded, snapped (using detents), ultrasonically welded, or otherwise attached to housing 24. The camera can be configured such that a central portion of bias spring (a portion along the length thereof and proximate the middle thereof) does not contact any structure, such that desired operation of bias spring 37 is not inhibited by friction with a structure. Thus, bias spring 37 is captured intermediate housing 24 and armature or magnet assembly 25 such that it biases focusing lens 21 at the infinity focus position thereof.

Lens 21 can be biased by spring 37 so as to effectively provide focus at infinity (or any other desired distance) when no current flows through coils 31. Such biasing generally tends to minimize the travel required by lens 21 in order to effect focus, on average. It also provides a more desirable failure mode with respect to optics assembly 20, since such a failure is thus more likely to result in lens 20 becoming fixed at infinity focus, where it is more likely to be most useful. It also provides a desirable default focus in the event that an autofocus feature fails to function properly.

Referring now to FIG. 3, coils 31 can be mounted to a floor 32 of housing 24. Thus, coils 31 are fixed in position with respect to housing 24 such that it is magnet assembly 40 that moves substantially in response to current flow through coils 31.

Referring now to FIG. 4, magnet assembly 25 and stage assembly 40 are shown with coils 31 in position with respect thereto. Again, since coils 31 are attached to housing 24, it is magnet assembly 25 (and consequently stage 35, as well as lens 21 attached thereto) that moves when current flows through coils 31. It is worthwhile to note that snubber assembly 36 is also attached to housing 24 and thus functions as a guide for stage 35 and does not move with respect to housing 24. It is also worthwhile to note that snubber assembly 36 can be a snap together structure that generally sandwiches and captures stage 35 between the upper and lower members thereof. Flexures 51, in combination with snubber assembly 36, define and limit motion of stage 35 substantially to the single desired degree of freedom, i.e., along an axis that facilitates focusing of the camera.

Referring now to FIG. 5, coils 31 are shown removed from the assembly of FIG. 5 to better show the outboard 28 and inboard 29 magnets thereof. Outboard flux guides 50 tend to make the magnetic field formed by outboard magnets 28 and inboard magnet 29 more uniform, especially proximate coils 31. Outboard flux guides 50 also tend to mitigate undesirable fringe effects whereby outer portions of the field do not contribute to the Lorentz force that effects movement of lens 21. That is, flux guides 50 tend to concentrate the flux in a manner that enhances its effectiveness for use in causing motion in response to current flow in coils 31. The use of multiple coils 31 and magnets 28 and 29 also tends to mitigate undesirable fringe effects.

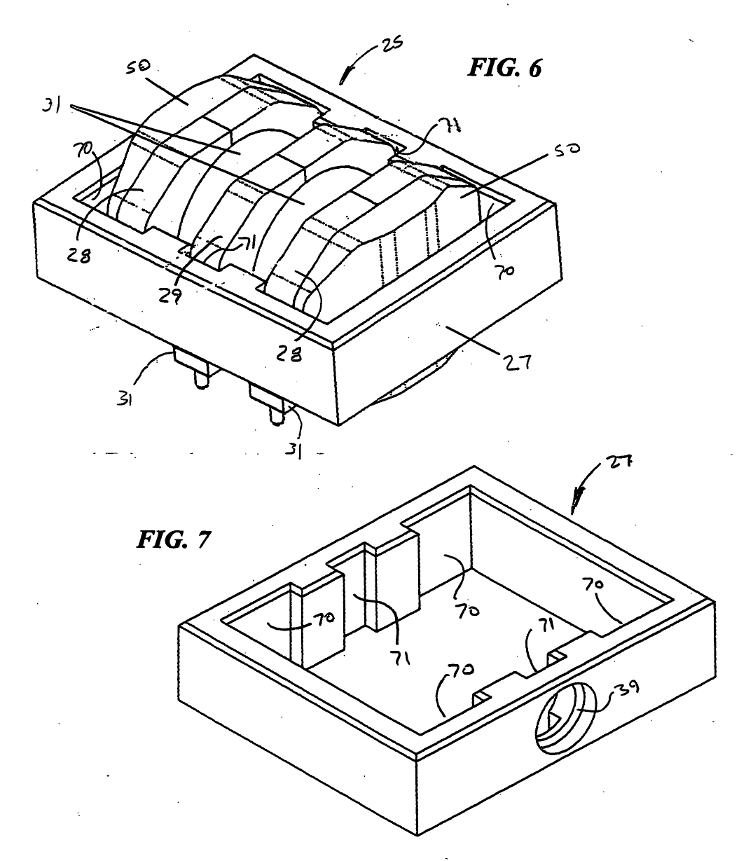

Referring now to FIG. 6, magnet assembly 25 is shown with coils 31 in place and with stage assembly 40 removed therefrom. The relative positioning of coils 31 with respect to outboard 28 and inboard 29 magnets can be seen. Further, outboard slots 70 and inboard slots 71 are configured so as to hold outboard 28 and inboard 29 magnets in the desired relative positions. As those skilled in the art will appreciate, outboard 28 and inboard 29 magnets are oriented such that they attract one another. Outboard 70 and inboard 71 slots help prevent outboard 28 and inboard 29 magnets from moving undesirably toward one another due to such attraction.

Referring now to FIG. 7, frame 27 of magnet assembly 25 is shown with outboard magnets 28, inboard magnet 29, and outboard flux guides 50 removed. Frame 27 can be formed of various non-ferrous materials such a plastic and silicon. The use of a non-ferrous material helps to maintain the magnetic field proximate the magnets 28, 29, where it is more effective in producing force upon coils 31 when current flows therethrough.

Spring seat 39 can defined by a lip or flange formed within a bore. One end of bias spring 37 is received within the bore and abuts the flange. In this manner, bias spring 37 pushes against the armature and thus urges lens optics assembly 27 away from bias spring 37 and toward the infinity focus position of lens 21.

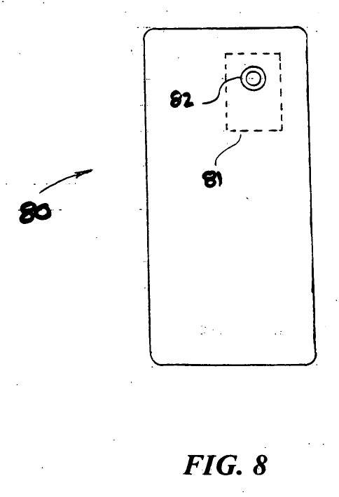

Referring now to FIG. 8, according to one embodiment of the present invention, the miniature camera 81 is part of a cellular telephone 80. The miniature camera may alternatively be a stand-alone device or may be part of another portable electronic device, such as a personal digital assistant (PDA), a notebook computer, or a laptop computer.

Such biasing of the focusing optics mitigates power consumption, provides a failsafe feature, and mitigates the detrimental effects associated with the use of autofocus upon a subject having fuzzy features.

The focusing optics can alternatively be biased at some position other than infinity focus. For example, if it is determined that, for a particular application, most photographs are taken at a distance of ten feet, then the focusing optics can be biased for focus at this distance.

Although the bias spring is described herein as being used with focusing optics, those skilled in the art will appreciate that a bias spring may similarly be used with other optical elements of a camera, such as zoom optics and/or image stabilization optics. Thus, description of the bias spring as being used with focusing optics is by way of example only, and not by way of limitation.

The spring can be a mechanical spring, such as a coil spring. Alternatively, the spring can be a non-mechanical spring, such as a magnetic or electrostatic spring. Those skilled in the art will appreciate that various types of springs are suitable.

Embodiments described above illustrate, but do not limit, the invention. It should also be understood that numerous modifications and variations are possible in accordance with the principles of the present invention. Accordingly, the scope of the invention is defined only by the following claims.

1. A miniature camera comprising:
movable optics for facilitating focusing of the camera; and
a spring for biasing the optics in a predetermined position.

2. The miniature camera as recited in claim 1, wherein the movable optics are configured to facilitate autofocus.

3. The miniature camera as recited in claim 1, wherein the movable optics are formed upon a movable stage and the spring biases the stage in a predetermined position.

4. The miniature camera as recited in claim 1, wherein the movable optics are formed upon a movable stage and the spring biases an actuator of the stage in a predetermined position.

5. The miniature camera as recited in claim 1, wherein the spring biases the movable optics in a position for focus at infinity.

6. The miniature camera as recited in claim 1, wherein the spring comprises a coil spring.

7. The miniature camera as recited in claim 1, wherein the spring comprises a coil compression spring.

8. The miniature camera as recited in claim 1, wherein the spring comprises a coil compression spring that contacts an armature of an actuator at one end thereof and contacts a fixed structure of the camera at another end thereof.

9. The miniature camera as recited in claim 1, wherein the spring comprises a coil compression spring that contacts an armature of an actuator at one end thereof, contacts a fixed structure of the camera at another end thereof, and doesn't contact any structures at a central portion thereof.

10. The miniature camera as recited in claim 1, wherein the spring comprises a coil compression spring that contacts an armature of an actuator at one end thereof, contacts a housing of the camera at another end thereof, and doesn't contact any structures at a central portion of the spring.

11. The miniature camera as recited in claim 1, wherein the spring is formed of a non-magnetic material.

12. The miniature camera as recited in claim 1, wherein the spring is formed of beryllium copper.

13. The miniature camera as recited in claim 1, wherein the spring is formed of stainless steel.

14. The miniature camera as recited in claim 1, wherein the spring comprises a mechanical spring.

15. A cellular telephone comprising a camera, the camera comprising:
movable optics for facilitating focusing of the camera; and
a spring for biasing the optics in a predetermined position.

16. A miniature camera comprising:
movable optics for facilitating focusing of the camera; and
means for biasing the optics in a predetermined position.

17. A cellular telephone comprising a camera, the camera comprising:
movable optics for facilitating focusing of the camera; and
means for biasing the optics in a predetermined position.

18. A method for operating a camera, the method comprising biasing movable optics of the camera in a predetermined position.

19. The method as recited in claim 18, wherein the movable optics are configured to facilitate autofocus of the camera.

20. The method as recited in claim 18, wherein biasing the movable optics comprises biasing a stage upon which the movable optics are disposed.

21. The method as recited in claim 18, wherein biasing the movable optics comprises biasing an armature of an actuator with respect to which the movable optics are responsive.

22. The method as recited in claim 18, wherein the movable optics are biased in a position for focus at infinity.

23. The method as recited in claim 18, wherein the movable optics are biased with a spring.

24. The method as recited in claim 18, wherein the movable optics are biased with a coil compression spring.
